(19) United States
(12) Patent Application Publication
(10) Pub. No.: US 2008/0197951 A1
(43) Pub. Date: Aug. 21, 2008

(54) DRIVING METHOD FOR MAGNETIC ELEMENT

(75) Inventors: Hsueh-An YANG, Hsinchu (TW); Weileun FANG, Hsinchu (TW); Tsung-Lin TANG, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: NATIONAL TSING HUA UNIVERSITY, Hsinchu (TW)

(21) Appl. No.: 11/842,304

(22) Filed: Aug. 21, 2007

(30) Foreign Application Priority Data
Feb. 16, 2007 (TW) 096106288

(51) Int. Cl. H01F 7/02

(52) U.S. Cl. 335/306

(57) ABSTRACT

A method for driving a magnetic element is provided. The method includes steps of: a) providing a first magnetic field, b) providing a second magnetic field interacting with the first magnetic field to generate a magnetostatic field, c) putting the magnetic element into the magnetostatic field, and d) generating a magnetic torque by modulating the first magnetic field and the second magnetic field so as to drive the magnetic element.

### FIELD OF THE INVENTION

The present invention relates to a method for driving a magnetic element. In particular, the present invention is relevant to the method for driving a magnetic element by a magnetostatic force.

### BACKGROUND OF THE INVENTION

Micro scanning mirror manufactured using silicon as a substrate was first published in 1980. Since then, the micro scanning mirror has become an area of important research in the study of optical Micro Electro Mechanical Systems. The main applications of the micro scanning mirror include appliances such as, scanners, bar code machines, laser printers and projectors. In the application in projection display system, micro scanning mirrors are further categorized into three types: 1. two-dimensional matrix; 2. one-dimensional scanning system; and 3. raster-scanned system.

The most well-known example for two-dimensional matrix is the Digital Micromirror Device (DMD), also known as Digital Light Processor (DLP) technique, manufactured by Texas Instruments.

One example of one-dimensional scanning system is the Grating Light Valve (GLV) that adopts principles of light reflection.

The raster-scanned system responds to the light source. It either scans vertically and horizontally by using two separate mirrors or uses one mirror for both dimensions. This system is usually applied to virtual projection displays and laser projection displays.

The earlier Cathode Ray Tube Televisions belong to the category of raster-scanned scanning system. In a vacuum environment, the direction of deflection of electronic beams is controlled by magnetic fields. The electronic beams are projected towards the phosphorescent screen, the phosphorescent powders on which then become excited and emit light. Since the introduction of micro-electro-mechanical systems (MEMS), scanning mirrors based on light projection have been in continuous development. Their manufacture employs bulk micromachining technique and surface micromachining technique.

There are various approaches to drive micro scanning mirrors, and the most commons are the static actuation and the heat actuation. Due to the limitation of size effect, there are fewer examples of micro mirrors driven by magnetic actuation.

In principle, when the electric current is perpendicular to the magnetic field, Lorentz force will be generated. Such force could be utilized to control the micro scanning mirror.

Please refer to FIG. 1, which is a preferred embodiment of the structure of a conventional micromirror. As illustrated in FIG. 1, the micromirror 1, manufactured with silicon as substrate, was etched and lined with the electroplated copper conducting wire 3 by micro electroform. Two magnets (not shown) are then installed to provide a permanent magnetic field. When the current flows from torsion bar 2 to micromirror 1, it interacts with the magnetic field and Lorentz force is generated therefrom. Since the direction of current will change after passing through torsoin bar 2, the direction of resulting Lorentz force will also change, inducing torque at the micromirror 1. If the input signal is alternating current, the micromirror 1 will resonate in high motion. Since the driving source is electric current, wires must be thickened by electroplating in order to reduce its resistance and hence the Joule heat generated along the conducting wire. Furthermore, as wires could only be further processed by the flat machining, it is impossible to produce wires in the form of three-dimensional coils. Thus, wires are intertwined and usually routed by 3D crossing, for example, by connecting through jumper 4.

However, conventional micro mirrors driven by Lorentz force have two drawbacks. Firstly, wiring requires coils, the production of which incurs expense. Secondly, it is vital to avoid production of Joule heat when large electric currents pass through coils. To complicate matters, these two difficulties are not mutually exclusive. Although electroplating thickens wires and thus provides solution for problem of Joule heat, it increases wiring cost. If the thickness of wire is inadequate, too strong a current generating Joule heat will be able to melt wires. In addition, the structure of conducting wires is to be fully built during the process of electroplating, in order to eliminate any possibility of melting. This further raises production cost.

In light of these drawbacks of the prior arts, a method for driving a magnetic element via a magnetostatic force is provided. The magnetic element (composed of magnetic materials) is driven by the magnetostatic torque resulting from the interaction between external magnetic field and the magnetic element itself.

### SUMMARY OF THE INVENTION

In accordance with an aspect of the present invention, a method for a method for driving a magnetic element is provided. The method includes steps of: a) providing a first magnetic field, b) providing a second magnetic field interacting with the first magnetic field to generate a static magnetic field, c) putting the magnetic element into the magnetostatic field, and d) generating a magnetic torque by modulating the first magnetic field and the second magnetic field so as to drive the magnetic element.

Preferably, the first magnetic field is provided by two permanent magnets having opposite magnetisms.

Preferably, the second magnetic field is provided by a magnetic field generating device.

Preferably, the step d) is performed by controlling a current to the magnetic field generating device.

Preferably, the current is provided by a mixer.

Preferably, the current is modulated by a mixer and a current generating device.

Preferably, the magnetic element is a micro-electro-mechanical system element.

Preferably, the magnetic element is a single-axis element.

Preferably, the magnetic element is a dual-axis element.

In accordance with another aspect of the present application, a method for controlling a magnetic element is provided. The method includes steps of: a) providing a magnetostatic field resulting from an interaction of plural magnetic fields, b) setting the magnetic element into the magnetostatic field, and c) generating a magnetic torque by modulating the magnetostatic field so as to control the magnetic element.

Preferably, the plural magnetic fields include a variable magnetic field.

Preferably, the variable magnetic field has a direction and a magnitude and the direction and the magnitude are controlled by a current.

Preferably, the current is provided by a mixer.

Preferably, the current is modulated by a mixer and a current generating device.

Preferably, the magnetic element is a micro-electro-mechanical system element.

Preferably, the magnetic element is one of a single-axis element and a dual-axis element.

Preferably, the magnetic element is made of a magnetic material.

In accordance with a further respect of the present application, a method for driving a magnetic element is provided. The method includes steps of: a) providing an alternating magnetic field, b) putting the magnetic element into the alternating magnetic field, and c) generating a magnetic torque by modulating the alternating magnetic field so as to drive the magnetic element.

Preferably, the alternating magnetic field has a direction and a magnitude and the direction and the magnitude are controlled by a current.

Preferably, the magnetic element is a micro-electro-mechanical system element.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a diagram showing the structure of a conventional micro mirror;

FIG. 2A is a preferred embodiment of the driving structure in this application;

FIG. 2B is a preferred embodiment of the method for driving a magnetic element in this application;

FIGS. 3A and 3B show other preferred embodiments of the driving structure and the method for driving a magnetic element in this application;

FIG. 4 is a diagram showing the method for driving a magnetic element by a variable magnetic field generating device according to a preferred embodiment of the present application;

FIG. 5, which is a diagram showing a driving structure according to the preferred embodiment of the present invention; and

FIG. 6, which is a preferred embodiment of the projection system proposed in this application.

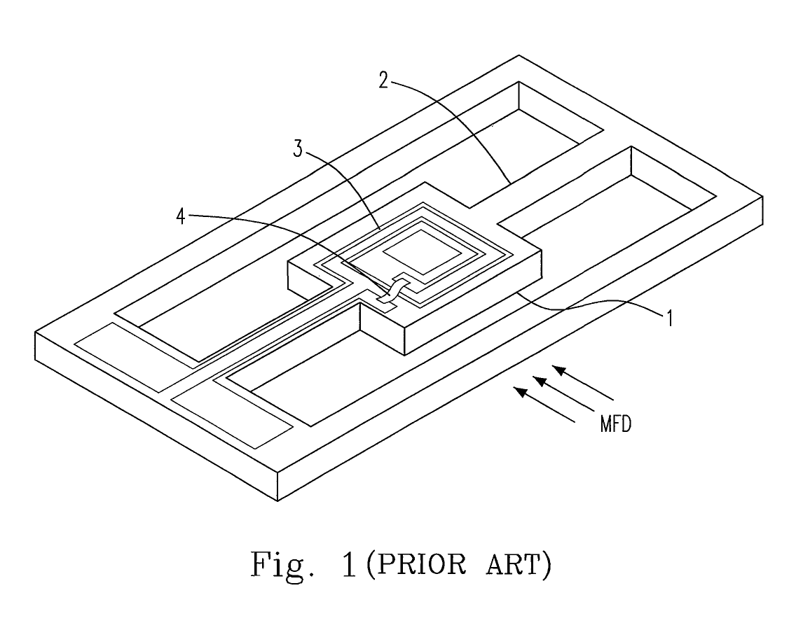

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

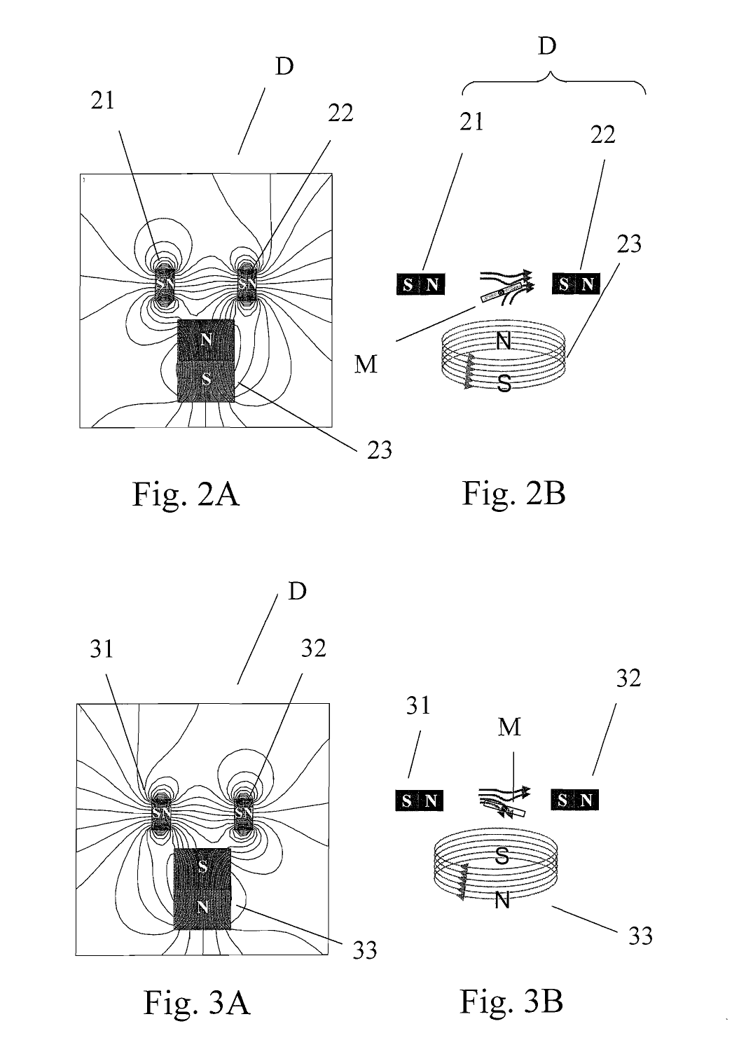

Please refer to FIGS. 2A and 2B, wherein FIG. 2A is a preferred embodiment of the driving structure in this application, and FIG. 2B is a preferred embodiment of the method for driving a magnetic element in this application. As illustrated in FIG. 2A, the driving structure D in this embodiment includes the first magnetic field generating device 21, the second magnetic field generating device 22, and the third magnetic field generating device 23. The first magnetic field generating device 21, the second magnetic field generating device 22 and the third magnetic field generating device 23 could be permanent magnets or temporary magnets, such as electromagets.

As shown in FIG. 2A, when the S-pole of the first magnetic field generating device 21 is on the left side thereof, the S-pole of the second magnetic field generating device 22 is on the left side thereof, and the S-pole of the third magnetic field generating device 23 is on the lower side thereof, there are interactions among the first magnetic field generating device 21, the second magnetic field generating device 22, and the third magnetic field generating device 23, and the formed magnetic field distributions are not uniform. When a magnetic element M is put into the driving structure D, as shown in FIG. 2B, the magnetic element M would receive a torque. It is to be noted that, when the strengths and relative locations of the first magnetic field generating device 21, the second magnetic field generating device 22, and the third magnetic field generating device 23 are fixed, the torque to be received would be determined by the location of the magnetic element M. On the other hand, if the location of the magnetic element M is fixed, the torque would be determined by controlling the strengths and/or relative locations of the first magnetic field generating device 21, the second magnetic field generating device 22, and the third magnetic field generating device 23. The mentioned magnetic element M could be made of a hard magnetic material or a soft magnetic material. The magnetic element M could be a single-axis element or a dual-axis element. There is a rotating axis in the magnetic element M. The preferred materials for the magnetic element M include ferrum, cobalt, nickel, dysprosium, aluminum, chromium, wolfram, platinum, silver, copper, lead, mercury and bismuth.

Please refer to FIGS. 3A and 3B, wherein show other preferred embodiments of the driving structure and the method for driving a magnetic element in this application.

As shown in FIG. 3A, when the S-pole of the first magnetic field generating device 31 is on the left side thereof, the S-pole of the second magnetic field generating device 32 is on the left side thereof, and the S-pole of the third magnetic field generating device 33 is on the upper side thereof, there are interactions among the first magnetic field generating device 31, the second magnetic field generating device 32, and the third magnetic field generating device 33, and the formed magnetic field distributions are not uniform. Similar to FIG. 2B, when a magnetic element M is put into the driving structure D, as shown in FIG. 3B, the magnetic element M would receive a torque.

As shown in FIGS. 2A, 2B, 3A and 3B, it is to be noted that, when the location of the magnetic element M is fixed, for the user, it is possible to determine the direction of the magnetostatic field by controlling the strengths and/or relative locations and/or the magnetic-pole distribution of the first magnetic field generating devices so as to determine the rotating status of the magnetic element. Namely, for the user, based on the mentioned embodiments, it is possible to determine the magnetostatic force direction and the rotating status of the magnetic element by controlling the location of the magnetic element, and/or the locations and/or strengths and/or the magnetic-poles distributions of the magnetic field generating devices.

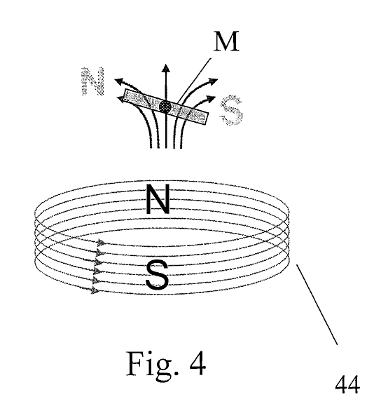

In addition, it should be noted that it is also practical to set only two magnetic fields and a magnetic element. In such a case, it is possible to determine the rotating status of the magnetic element by controlling the interaction between the two magnetic fields. Furthermore, it is also practical to control the rotating status of the magnetic element when only a variable magnetic field exists. As shown in FIG. 4, it is possible to determine the rotating status of the magnetic element M by controlling the magnetic field of the magnetic field generating device 44.

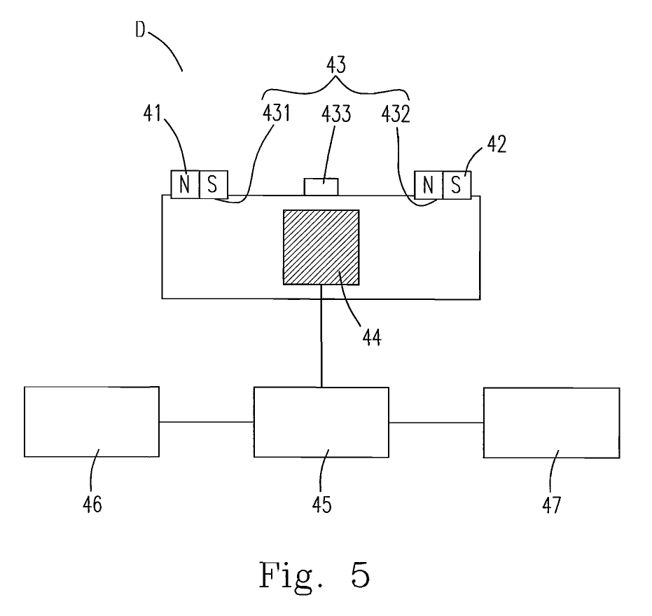

Please refer to FIG. 5, which is a diagram showing a driving structure according to the preferred embodiment of the present invention. As shown in FIG. 5, the driving structure D includes a first magnetic field generating device 41, a second magnetic field generating device 42, a frame 43, the third magnetic field generating device 44 (such as solenoid), the mixer 45, the first current generating device 46 and the second current generating device 47. It is to be noted that the first current generating device 46 and the second current generating device 47 (and the mixer 45) could be considered as a current source device. Among these, the third magnetic field generating device 44 is applied to a magnetic element (not shown) to provide a variable magnetic field. Thus, its installation position is adjustable, providing that it is able to modify the magnetic field of the magnetic element. Furthermore, although both the first magnetic field generating device 41 and the second magnetic field generating device 42 in this embodiment use permanent magnets, other designs are appropriate during actual operation, as long as the magnetic force persists. In addition, the frame 43 includes the first supporting portion 431, the second supporting portion 432 and the third supporting portion 433 that carry the first magnetic field generating device 41, the second magnetic field generating device 42 and the magnetic element (not shown) respectively. Although this embodiment encompasses two current generating devices 46 and 47 and one mixer 45, one current source controller is adequate for controlling the change of magnetic field during actual operation.

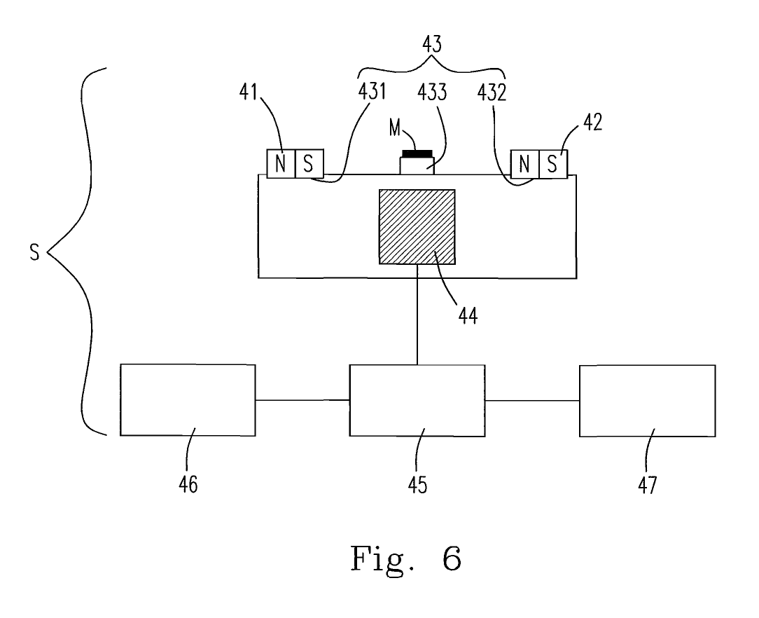

Please refer to FIG. 6, which is a preferred embodiment of the projection system proposed in this application. As illustrated in FIG. 6, the projection system S in this embodiment includes the micro scanning mirror M, and the first magnetic field generating device 41, the second magnet device 42, the frame 43, magnetic field generating device 44 (such as solenoid), the mixer 45, the first current generating device 46, and the second current generating device 47 in FIG. 5. Amongst these, the frame 43 includes the first supporting portion 431, the second supporting portion 432 and the third supporting portion 433 that carry the first magnetic field generating device 41, the second magnetic field generating device 42 and the micro scanning mirror M respectively. The driving structure D shown in FIG. 5 has been disclosed in the Applicant's preceding patent application, U.S. Ser. No. 11/650,402 field on Jan. 15, 2007. Although the driving structure has been disclosed in the mentioned application, the method of determining the motion status of the magnetic element (preferably a Micro Electro Mechanical, such as a micro scanning mirror) by controlling the magnetostatic force is not disclosed in the mentioned application.

As described above, the present application provides a method for driving a magnetic element, such as a method for driving a micro scanning mirror. In the present application, it is possible to drive a magnetic element via a non-contact manner by controlling the magnetic field strengths, and/or the magnetic field distributions, and/or the location of the magnetic element. The magnetic element could be a single-axis element, a dual-axis element. Furthermore, the flexibilities of the relative positions between the magnetic field generating devices and the magnetic element, and the magnetic field distributions diversify the applications of this invention. The driving method for the magnetic element is not disclosed in prior art, and the present application has the advantages, such as the high flexibilities of the driving structure and the simple driving processes. Thus, this embodiment possesses originality, non-obviousness and huge industrial applicability. Last but not least, although the micro scanning mirror is illustrated in the preferred embodiment, the driving method of the embodiment is not restricted to MEMS element and is of potential to be further applied to other fields.

While the invention has been described in terms of what is presently considered to be the most practical and preferred embodiment, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for driving a magnetic element, comprising steps of:
a) providing a first magnetic field;
b) providing a second magnetic field interacting with the first magnetic field to generate a static magnetic field;
c) putting the magnetic element into the magnetostatic field; and
d) generating a magnetic torque by modulating the first magnetic field and the second magnetic field so as to drive the magnetic element.

2. A method as claimed in claim 1, wherein the first magnetic field is provided by two permanent magnets having opposite magnetisms.

3. A method as claimed in claim 1, wherein the second magnetic field is provided by a magnetic field generating device.

4. A method as claimed in claim 3, wherein the step d) is performed by controlling a current to the magnetic field generating device.

5. A method as claimed in claim 4, wherein the current is provided by a mixer.

6. A method as claimed in claim 4, wherein the current is modulated by a mixer and a current generating device.

7. A method as claimed in claim 1, wherein the magnetic element is a micro-electro-mechanical system element.

8. A method as claimed in claim 1, wherein the magnetic element is a single-axis element.

9. A method as claimed in claim 1, wherein the magnetic element is a dual-axis element.

10. A method for controlling a magnetic element, comprising steps of:
a) providing a magnetostatic field resulting from an interaction of plural magnetic fields;
b) setting the magnetic element into the magnetostatic field; and
c) generating a magnetic torque by modulating the magnetostatic field so as to control the magnetic element.

11. A method as claimed in claim 10, wherein the plural magnetic fields include a variable magnetic field.

12. A method as claimed in claim 11, wherein the variable magnetic field has a direction and a magnitude and the direction and the magnitude are controlled by a current.

13. A method as claimed in claim 12, wherein the current is provided by a mixer.

14. A method as claimed in claim 12, wherein the current is modulated by a mixer and a current generating device.

15. A method as claimed in claim 10, wherein the magnetic element is a micro-electro-mechanical system element.

16. A method as claimed in claim 10, wherein the magnetic element is one of a single-axis element and a dual-axis element.

17. A method as claimed in claim 10, wherein the magnetic element is made of a magnetic material.

18. A method for driving a magnetic element, comprising steps of:
a) providing an alternating magnetic field;
b) putting the magnetic element into the alternating magnetic field; and
c) generating a magnetic torque by modulating the alternating magnetic field so as to drive the magnetic element.

19. A method as claimed in claim 18, wherein the alternating magnetic field has a direction and a magnitude and the direction and the magnitude are controlled by a current.

20. A method as claimed in claim 18, wherein the magnetic element is a micro-electro-mechanical system element.
